(19) United States
(12) Patent Application Publication
(10) Pub. No.: US 2016/0300020 A1
(43) Pub. Date: Oct. 13, 2016

(54) CONSTRAINT-BASED MEDICAL CODING

(71) Applicant: 3M INNOVATIVE PROPERTIES COMPANY, Saint Paul, MN (US)

(72) Inventors: Andrew C Wetta, Chevy Chase, MD (US); Jeremy R. Kornbluth, Chevy Chase, MD (US)

(21) Appl. No.: 15/100,672

(22) PCT Filed: Nov. 24, 2014
(86) PCT No.: PCT/US14/67046

§ 371 Date: Jun. 1, 2016

Related U.S. Application Data
(60) Provisional application No. 61/911,169, filed on Dec. 3, 2013.

(51) Int. Cl. G06F 19/00; G06F 17/30; G06F 17/27; G06F 17/24

(52) U.S. Cl. CPC G06F 19/322; G06F 17/241; G06F 17/30011; G06F 17/2705; G06F 19/328

(57) ABSTRACT

This disclosure describes systems, devices, and techniques for abstracting and coding medical documents. In one example, a method includes receiving a medical document comprising a plurality of tokens, annotating at least one of the plurality of tokens with one or more concepts, parsing the plurality of tokens of the medical document to identify one or more syntactic structures, and abstracting, by the computing device, each of the one or more syntactic structures to a semantic representation based on the parsing and the respective concepts. The method may also include determining, based on the semantic representation of at least one of the respective one or more syntactic structures, one or more medical codes representative of information contained in the medical document and outputting the medical code for the medical document.

### TECHNICAL FIELD

The invention relates to systems and techniques for coding medical documentation.

### BACKGROUND

In the medical field, accurate processing of records relating to patient visits to hospitals and clinics ensures that the records contain reliable and up-to-date information for future reference. Accurate processing may also be useful for medical systems and professionals to receive prompt and precise reimbursements from insurers and other payors. Some medical systems may include electronic health record (EHR) technology that assists in ensuring records of patient visits and files are accurate in identifying information needed for reimbursement purposes. These EHR systems generally have multiple specific interfaces into which medical professionals may input information about the patients and their visits.

### SUMMARY

In general, this disclosure describes systems and techniques for abstracting and coding medical documents. For example, the techniques and systems described herein may abstract syntactic structures of a medical document to semantic representations of the respective syntactic structures. A system may use these semantic representations to select one or more medical codes appropriate for the medical document through a constraint-based approach. The semantic representations may be applicable to different types of medical classification codesets that identify diseases, disorders, treatments, or any other medical information. In addition, the techniques and systems may group semantic representations having related semantic actions to constrain the possible medical codes and select a medical code for each group of semantic representations from each medical document.

In one example, this disclosure describes a computer-implemented method for coding medical documentation, the method including receiving, by a computing device, a medical document comprising a plurality of tokens, annotating, by the computing device, at least one of the plurality of tokens with one or more concepts, parsing, by the computing device, the plurality of tokens of the medical document to identify one or more syntactic structures, abstracting, by the computing device, each of the one or more syntactic structures to a semantic representation based on the parsing and the respective concepts, determining, by the computing device and based on the semantic representation of at least one of the respective one or more syntactic structures, one or more medical codes representative of information contained in the medical document, and outputting, by the computing device, the medical code for the medical document.

In another example, this disclosure describes a computerized system for coding medical documentation, the system including one or more computing devices configured to receive a medical document comprising a plurality of tokens, annotate at least one of the plurality of tokens with one or more concepts, parse the plurality of tokens of the medical document to identify one or more syntactic structures, abstract each of the one or more syntactic structures to a semantic representation based on the parsing and the respective concepts, determine, based on the semantic representation of at least one of the respective one or more syntactic structures, one or more medical codes representative of information contained in the medical document, and output the medical code for the medical document.

In an additional example, this disclosure describes a computer-readable storage medium including instructions that, when executed, cause a processor to receive a medical document comprising a plurality of tokens, annotate at least one of the plurality of tokens with one or more concepts, parse the plurality of tokens of the medical document to identify one or more syntactic structures, abstract each of the one or more syntactic structures to a semantic representation based on the parsing and the respective concepts, determine, based on the semantic representation of at least one of the respective one or more syntactic structures, one or more medical codes representative of information contained in the medical document, and output the medical code for the medical document.

The details of one or more examples of the described systems, devices, and techniques are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example distributed system configured to abstract and/or code medical documents via a network consistent with this disclosure.

FIG. 2 is a block diagram illustrating the server and repository of the example of FIG. 1.

FIG. 3 is a block diagram illustrating a stand-alone computing device configured to abstract and/or code medical documents.

FIG. 4 is a flow diagram illustrating an example technique for abstracting one or more syntactic structures of a medical document.

FIG. 5 is a flow diagram illustrating an example technique for coding a medical document using one or more semantic representations associated with the medical document.

### DETAILED DESCRIPTION

This disclosure describes systems and techniques for abstracting and/or coding medical documentation via one or more computing devices. Typically, medical documentation may include an overview of a patient's health status or condition, past care, diagnosis, treatment information, along with any notes written by physicians, nurses, or other medical professionals. The medical documentation may take the form of a variety of different forms or records, physical or electronic. The medical documentation may be entered into an electronic health record (EHR) for each patient. Thus, the medical documentation may be digitized to facilitate storage and distribution of the medical documents.

Some EHR systems may include computer systems that perform a process termed computer-assisted coding (CAC). CAC is a process for analyzing medical documents and identifying medical codes using the text, or words and phrases, contained within the medical documentation. For example, the CAC process converts the text of the document to medical codes using machine learning to identify the specific words or phrases within the medical documentation. Generally, the accuracy of the CAC process may be dependent upon the actual words used, the context in which the words are used, and/or the order of words in the text of the medical documentation. Moreover, different types of medical codesets (e.g., different medical coding systems) may identify different medical codes for the same medical document due to variations on how each codeset relates to the same words or phrases used within the medical documentation.

As described herein, various systems and techniques may perform an abstraction of the syntactic structures derived from words and phrases used in the medical documentation to generate respective semantic representations and/or determine one or more medical codes based on the semantic representations. In this manner, one or more computing devices may be configured to conceptualize, or abstract, one or more tokens (e.g., tokenized words and/or phrases) in the text of medical documents to facilitate more accurate and consistent medical coding of the medical documentation. Using abstract concepts for one or more syntactic structures, such as medical terms related to the diagnosis and/or treatment of a medical patient, the medical code or codes applied to the medical documentation will not be dependent upon the specific words or type of language used by the medical professional to describe any interactions with the patient.

For example, a system may receive a medical document to be coded. The system may first generate an abstraction of one or more syntactic structures used within the text of the document. The system may annotate one or more tokens of the medical document with one or more respective concepts from a knowledge resource (e.g., an electronic dictionary or ontological resource) and parse the medical document to identify syntactic structure (e.g., the relationships between tokens that describe the content of the medical document). The system may then abstract the syntactic structures to respective semantic representations based on the respective concepts from the knowledge resources and the parsed syntactic structures. For example, each semantic representation may include a semantic action indicative of an action that occurred with regard to a patient. In this manner, the system may conceptualize one or more aspects of the medical document to facilitate subsequent medical coding of the document. The semantic representations (e.g., and the parsed tokens and/or annotations) may be stored for later coding or transferred to another system that performs the coding process.

The system may then code the abstracted medical document using a selected codeset. The system may compare semantic representations of respective syntactic structures to a list of medical codes of the selected codeset and select the medical codes that match the respective semantic representations. In some examples, the system may group semantic representations with related semantic actions and determine a medical code for the group. Each semantic representation may be referred to as a constraint on the codeset such that more semantic representations may further narrow the possible medical codes for the group. If multiple medical codes are determined as applicable to the semantic representation or group of semantic representations, the system may apply one or more rules to select one of the multiple medical codes for describing the medical document. This approach to medical coding may be referred to as a “constraint-based” approach because each of the semantic representations may constrain the possible pool of medical codes so that a single medical code can be selected for each semantic representation or group of semantic representations. In this manner, the abstracted medical document may be used with the codeset of any medical coding system to result in more accurate and more consistent selection of medical codes.

As described herein, medical documents may include medical information related to a medical patient. Each medical document may be segmented, arranged, or otherwise generated into different sections, in some examples. Although, some medical documents may be a continuous document without any segmentation. In any case, each medical document may thus be comprised of one or more regions that may be identified and analyzed. A region may refer to a portion or subset of the information contained in the medical document. In one example, a region may refer to a section of the medical document separated by different headers or other markers. For example, each region may be defined when the document is generated or pre-processed to identify and label different regions of the document that related to different aspects of the patient's history (e.g., diagnosis and procedure). In another example, a region may refer to a page of the medical document, such as one of a plurality of digital pages or a representation of a piece of paper that was scanned into the system as part of a medical document and separated by digital page breaks. The examples described herein will refer to medical documents, but these documents may include one or more separated regions, pages, or sections each including medical information related to a patient. Although the patients described herein are generally human patients, the systems and techniques described herein may also apply to non-human patients.

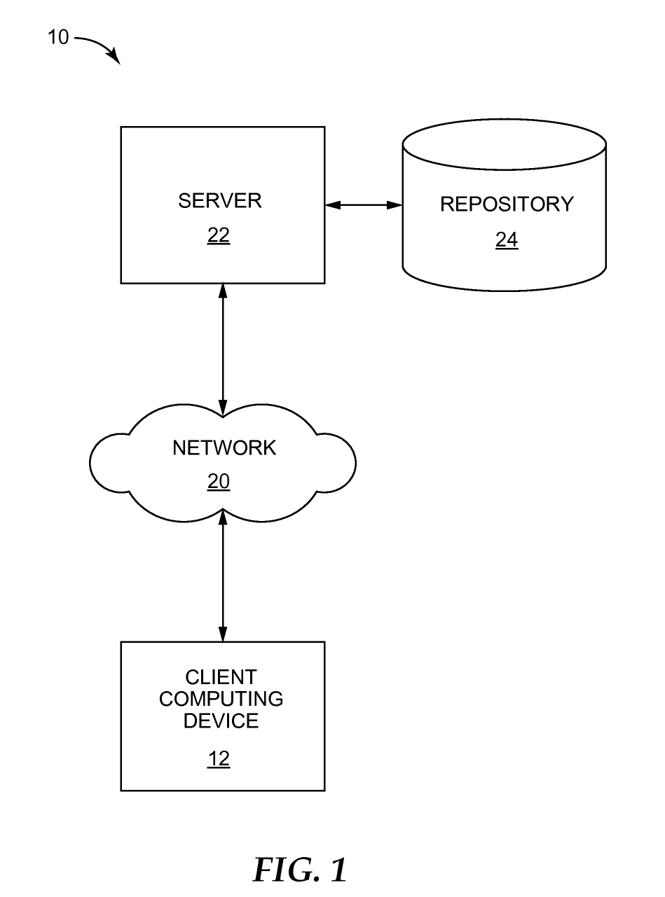

FIG. 1 is a block diagram illustrating an example distributed system 10 configured to abstract and/or code medical documents via a network consistent with this disclosure. As described herein, system 10 may include one or more client computing devices 12, a network 20, server computing device 22, and repository 24. Client computing device 12 may be configured to communicate with server 22 via network 20. Server 22 may receive various requests from client computing device 12 and retrieve various information from repository 24 to address the requests from client computing device 12. In some examples, server 22 may generate information, such as abstracted medical documents and/or medical codes for client computing device 12.

Server 22 may include one or more computing devices connected to client computing device 12 via network 20. Server 22 may perform the techniques described herein, and a user may interact with system 10 via client computing device 12. Network 20 may include a proprietary or non-proprietary network for packet-based communication. In one example, network 20 may include the Internet, in which case each of client computing device 12 and server 22 may include communication interfaces for communicating data according to transmission control protocol/internet protocol (TCP/IP), user datagram protocol (UDP), or the like. More generally, however, network 20 may include any type of communication network, and may support wired communication, wireless communication, fiber optic communication, satellite communication, or any type of techniques for transferring data between two or more computing devices (e.g., server 22 and client computing device 12).

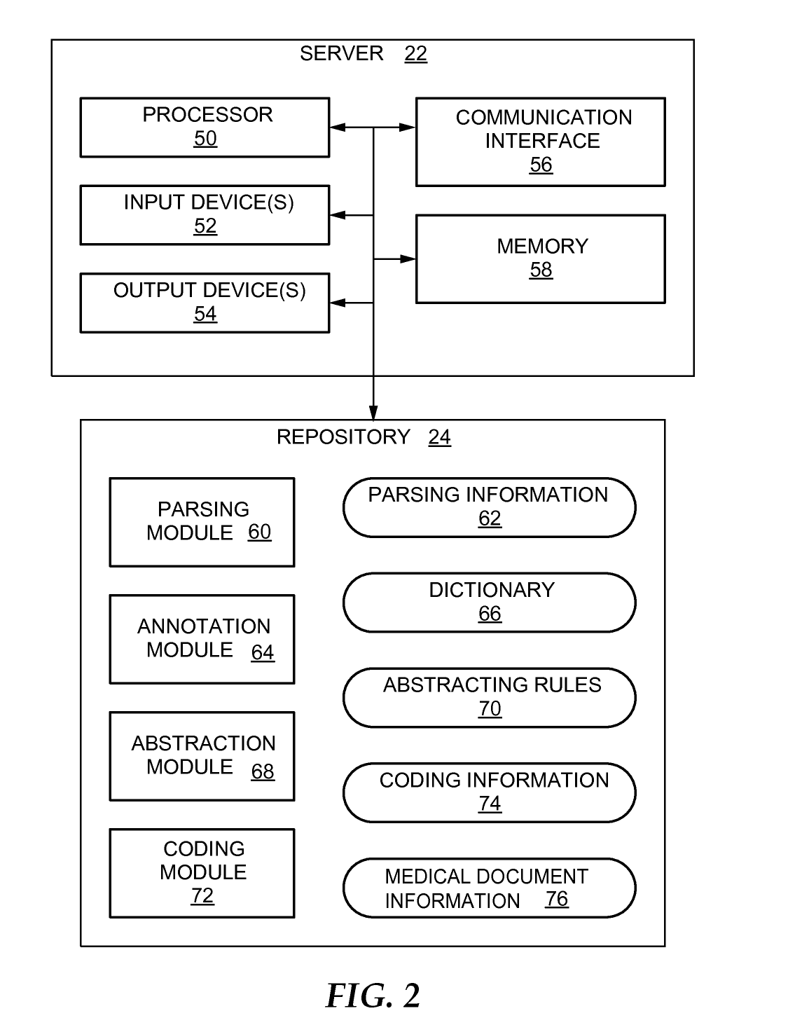

Server 22 may include one or more processors, storage devices, input and output devices, and communication interfaces as described in FIG. 2. Server 22 may be configured to provide a service to one or more clients, such as abstracting medical documents and/or determining one or more medical codes that represent the information contained by the medical documents. Server 22 may operate on within a local network or be hosted in a Cloud computing environment. Client computing device 12 may be a computing device associated with an entity (e.g., a hospital, clinic, university, or other healthcare organization) that utilizes medical codes for understanding the information contained within medical documents. Examples of client computing device 12 include personal computing devices, computers, servers, mobile devices, smart phones, tablet computing devices, etc. These medical codes may be used to populate an EHR, track patient history, and/or generate billing for healthcare services. Client computing device 12 may be configured to upload one or more medical documents to server 22 for abstraction and/or coding by server 22. Alternatively, client computing device 12 may be configured to retrieve abstracted and/or coded medical documents generated by server 22 and stored in repository 24. In any example, client computing device 12 may obtain medical codes for medical documents via server 22. Server 22 may also be configured to communicate with multiple client computing devices 12 associated with the same entity and/or different entities.

System 10 may include a computerized system for coding medical documentation. As described herein, server 22 may include one or more processors configured to receive or obtain a medical document including a plurality of words (which may be tokenized to include one or more tokens), annotate at least one of the tokens with one or more respective concepts, parse the medical document to identify one or more syntactic structures, and abstract each of the one or more syntactic structures to a semantic representation based on the parsing and the respective concepts of the syntactic structures. In addition, server 22 may be configured to determine, based on at least one of the semantic representations of the one or more syntactic structures in the medical document, one or more medical code representative of information contained in the medical document. Server 22 may then output the one or more medical codes for the medical document, such as transmitting the medical code to client computing device 12 or other system and/or storing the medical code in repository 24.

A medical document may include any medical information related to a medical patient. The medical document may be a digitized version of a paper document or an electronic document generated on another computing device. Server 22 may receive the medical document from client computing device 12 during a request to code the document or from repository 24 when server 22 is instructed to perform the abstraction and/or coding process. Each medical document may include a plurality of words in a particular language, such as English or Spanish.

The medical documents may include some form of preprocessing prior to being received by server 22. Client computing device 12 or server 22 may perform one or more aspect of the preprocessing. For example, the medical documents may be regioned documents in which respective regions of each medical document have already been labeled with appropriate region uses (e.g., preoperative diagnosis, description of procedure, etc.). The system may use one or more rules to define each region, such as text formatting cues and/or context of the information. Server 22 may tokenize to break up the text of the document into one or more separate tokens (e.g., a word or set of words), as well as parse, abstract, and/or code different regions according to different instructions. The preprocessing of the medical documents may also include de-identification to remove or anonymize sensitive information such as personal or otherwise private patient information or other protected health information (PHI).

Server 22 may tag some or all of the words in the received medical document with its respective part of speech (e.g., a noun, verb, adjective, adverb, etc.). These parts of speech may assist in the parsing performed later. The tagging of words with parts of speech may be done at any point prior to the parsing process. In some examples, server 22 may apply a statistical model on the annotated medical document to identify the parts of speech (e.g., verb, noun, and adjective) for each word. Server 22 may also tokenize the text of the medical document to break up the text of the document into one or more separate tokens. Each token may include a word or a phrase of two or more words related to the healthcare of the patient. In some examples, all words may be separated or grouped into a respective token. In other examples, only some of the words may be separated into respective tokens.

Server 22 may also annotate the one or more tokens of the medical document with one or more concepts related to the token. This annotation may include identification of a token or string of tokens that matches a concept contained within an entry of a dictionary. Not all the tokens may be annotated, in some examples. For example, server 22 may annotate body parts, medical devices, procedures, actions, or any other words related to the identification of the medical information. Server 22 may annotate the words by matching each of the at least one of the one or more words to a respective entry of one or more knowledge resources (e.g., electronic dictionaries and/or ontological resources). Each of the respective entries may include a respective concept of the respective word. Each concept may thus be selected from a dictionary of a curated taxonomy of medically related concepts. Each concept may be represented by an entry of one or more words, one or more characters, or one or more numbers. In this manner, each connect may have a “concept ID” that references the concept of the token or tokens. Server 22 may then annotate at least one of the one or more tokens with the respective concept or concept ID.

After the words are annotated, server 22 may parse the medical document based on the parts of speech and the annotation for each token to identify the syntactic structure of the text in the document, that is, the groupings and relationships between tokens. This parsing process may include dividing text into sentences, the sentences into clauses, clauses into phrases (e.g. noun, verb, adverbial, and prepositional phrases), and phrases into their subparts, which may include individual words or recursively additional phrases. Such a parse may identify the actions within a document (e.g., the verbs), the arguments of those actions (e.g., the noun phrases), and the modifiers of these actions and arguments (e.g., the adverbial and prepositional phrases as well as the adjectives within noun phrases). These relationships may be generally bounded within a single clause but may extend across multiple clauses in some examples including anaphora (e.g., determining what “it” refers to) and co-reference resolution. In one example, server 22 may utilize a rule-based parsing process where a set of rules, forming a grammar, are recursive and cascading. In such an example, the order of each rule may affect the final parses.

Based on the parsed text and the concepts of the annotations, server 22 may then determine semantic representations of the syntactic structures within the medical document. These semantic representations are conceptual or abstracted representations of the specific relationships between tokens (e.g., words and phrases) contained within the medical document. For example, these semantic representations may characterize a semantic action and the entities that performed or underwent the action (e.g., descriptive features) as well as any related information such as the instrument used to perform the action or the location where the action took place with regard to the treatment of the patient. When abstracting over the complex syntactic structures of a medical document, server 22 may identify abstractions regardless of the manner in which language was used to describe the actions. For example, a single abstraction may represent both of the following example sentences: “Doctor X performed procedure Y” and “Procedure Y was performed by Doctor X.” The semantic representations of each of these sentences may have a common semantic action (procedure Y) and related descriptive features (e.g., Doctor X). The descriptive features of the semantic representation may provide details regarding the semantic action of the same semantic representation. As shown, a healthcare professional may use the English language to describe the same procedure in various ways. Therefore, each of the semantic representations may conceptualize or abstractly identify different syntactic structures to eliminate possible confusion related to the different possible ways a procedure or diagnosis may be described. That is, a single semantic representation may map to many different possible syntactic structures and realizations in a text. This single semantic representation may then include one or more concepts that are directly relatable to one or more medical codes. Therefore, server 22 may be able to determine medical codes that collectively correspond to the respective semantic representations. Server 22 may transmit the semantic representations of the medical document back to client computing device 12 and/or store the semantic representations in repository 24.

Server 22 may generate the semantic representations into a specific format usable for efficient processing and subsequently medical coding. For example, server 22 may transform the semantic representations into respective resource description framework (RDF) triples. RDF triples are a metadata model expressed in extensible markup language (XML) to describe the relationships between entities, abstract ideas, or characteristics. In this notation, an RDF triple may include a subject, predicate, and object (not to be confused with the syntactic structures of the same name). The subject may denote some entity; the object may denote some other entity, idea, or characteristic; and the predicate expresses the type of relationship between the subject and the object. In this manner, a format such as RDF triples may reflect the information contained in each semantic representation through a process known as reification, where the semantic representation, expressed as some event, is the subject of multiple triples and the predicates and objects describe its various properties. However, other formats besides RDF triples may be used in other examples.

The one or more semantic representations may summarize the information content of the document. By using semantic representations, server 22 may apply a medical codeset without regard to whether or not each code of the codeset is written to specifically recognize, or match, different text strings that may describe the same concept. Instead, each semantic representation may abstract a portion of the document text such that the semantic representation is then matched to an appropriate medical code. In other words, the semantic representations allow server 22 to match medical codes to abstracted ideas instead of needing to match medical codes to a specific one or more text strings.

Server 22 may use the sematic representations as input to a coding module that selects medical codes representing the information of the medical document. Server 22 may determine the appropriate medical code, or set of medical codes, that corresponds to the generated semantic representations. Each medical document may have one or more semantic representations generated to abstractly describe the information within the medical document. In some examples, server 22 may determine the appropriate medical code for the document using a single semantic representation (whether or not the document has more than one semantic representation). For example, server 22 may apply a semantic representation to a list of medical codes of a selected codeset and obtain a single matching medical code from the codeset.

However, server 22 may also combine semantic representations having related semantic actions into respective groups of semantic representations. Each of the semantic representations of the medical document may include a semantic action that indicates something about the subject of the semantic representation or what occurred in the semantic representation. Each semantic action may be referred to as a predicate, which may be derived from a noun, verb, or other token. In a medical document, there may be multiple different semantic representations with related semantic actions. This may occur when the medical professional describes the procedures or conditions of the patient. In some examples, the related semantic actions may be the same semantic actions or semantic actions otherwise related to similar concepts. The different semantic representations within a single group may then more clearly identify a procedure, process, diagnosis, or any other medical item associated with the patient than a single semantic representation can describe. In other words, each semantic representation may include slightly different information related to the medical document. Therefore, each of the semantic representations within the group may be a constraint on possible medical codes applicable to the medical document. Server 22 may thus determine one or more medical codes that match each group of semantic representations. However, in some examples, a group of semantic representations may only include one semantic representation. The single semantic representation may still be sufficient to determine a single matching medical code in some examples.

In other words, server 22 may combine all compatible semantic representations and their respective codes, or set of codes, to find a shared medical code, or set of codes, which reflects the aggregate semantic meaning of all or part of the medical document. Semantic representations may be deemed compatible if they share any corresponding medical codes. While trying to combine all semantic representations in a medical document, server 22 may create multiple distinct groupings of codes, or sets of codes. In this manner, server 22 may find multiple valid codes for a single medical document. The medical codes associated with a particular semantic representation constrain the list of possible medical codes. Server 22 may combine the constraints of multiple semantic representations to determine a more specific and smaller set of medical codes. This process may thus “whittle down” the number of possible medical codes given the semantic evidence in the document until one or more medical codes are selected for the medical document.

In some examples, more than one medical code, or set of medical codes, may be determined for a group of one or more semantic representations. These multiple codes may not adequately describe the information contained within the medical document because they may refer to additional concepts not related to items of the medical document. In other words, the group of semantic representations may not have fully constrained the list of codes to only represent the information of the document. Responsive to determining that multiple medical codes have been selected for a group of semantic representations, server 22 may apply additional rules to the multiple medical codes in order to reduce the codes to a single medical code.

For example, server 22 may determine which one of the multiple medical codes for a group of semantic representations is a default medical code. The default code may be stored as a part of one or more rules (e.g., rule based constraints) identifying default codes or default selections to distinguish between multiple codes. The rules defining default codes may be generated based on feedback from medical coding experts, medical professionals, or any other experience-based knowledge base. For example, the multiple matching medical codes may refer to different details about a particular medical procedure, one code related to a common procedural detail and the other codes related to rarely used procedural details. In other examples, the process of selecting from multiple medical codes may include statistically determining which of the multiple codes are most likely to be applicable to the semantic representations of the group. In some examples, server 22 may predict the medical code based on the remaining medical codes and/or the medical codes that have been excluded from consideration during the code determination process. Server 22 may, for example, exclude remaining medical codes that are not related to the other codes already determined or exclude remaining medical codes similar to previously excluded codes.

Alternatively, server 22 may use other criteria when determining between multiple possible medical codes still remaining. For example, server 22 may apply additional rule-based constraints on the remaining possible medical codes. These rule-based constraints may be used in reverse, such as applying medical codes as constraints to the medical document to determine if any of the medical codes match the rest of the document. Server 22 may identify terms or phrases of the remaining medical codes. Server 22 may then generate semantic representations of the medical codes, or sets of medical codes, and compare them to the semantic representations of the medical document and determine if there are any matches. In one example, server 22 may run a query of the generated semantic representations transformed into SPARQL (SPARQL Protocol and RDF Query Language) which is applied against the RDF triples (i.e., the semantic representations) of the medical document. If server 22 determines a match, server 22 may add the corresponding medical code, or set of medical codes, as a further constraint to the medical document.

Server 22 may still have additional methods of selecting between multiple possible medical codes. For example, server 22 may calculate or determine a confidence interval for each of the remaining medical codes and select the medical code with the highest confidence interval. These statistical analyses based on the matches of one or more of the semantic representations to the remaining medical codes may be used, for example, after other constraint-based approaches described above do not result in the selection of a medical code or set of codes. In another example, server 22 may select between remaining medical codes by referring to a default code. For example, in predefined sets of codes, one particular code may be designated as the default. Server 22 may select this default code for the medical document.

The processes described with respect to FIG. 1 and herein may be performed by one or more servers 22. In other examples, client computing device 12 may perform one or more of the steps of the abstraction and/or coding process. In this manner, system 22 may be referred to a distributed system in some examples. Server 22 may utilize additional processing resources by transmitting some or all of the information related to the medical document to additional computing devices.

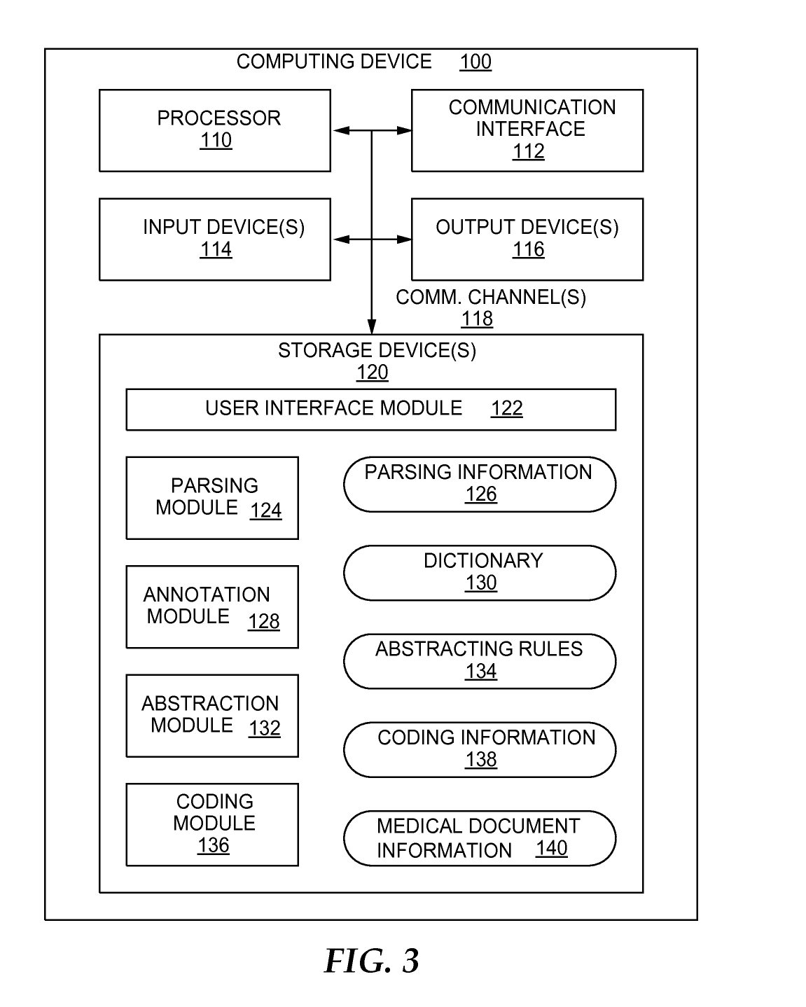

Client computing device 12 may be used by a user (e.g., a medical professional such as clinician, a healthcare facility administrator, or a medical coding expert) to upload or select medical documents for abstraction and/or coding as described herein. Client computing device 12 may include one or more processors, memories, input and output devices, communication interfaces for interfacing with network 20, and any other components that may facilitate the processes described herein. In some examples, client computing device 12 may be similar to computing device 100 of FIG. 3. In this manner, client computing device 12 may be configured to perform one or more steps of the abstraction and/or coding processes with the aid of server 22 in some examples.

The transmission, storage, or reception of medical documentation may include one or more medical documents and additional data. For example, additional data related to each medical document may be contained as metadata attached to each respective document or portion of the document. The metadata may include tagged parts of speech, parsed syntactic structures, annotations (e.g., concepts), semantic representations, and/or determined medical codes. In other examples, separate data files or databases may store one or more of these features and associate them with a respective medical document via reference to the document.

FIG. 2 is a block diagram illustrating server 22 and repository 24 of the example of FIG. 1. As shown in FIG. 2, server 22 includes processor 50, one or more input devices 52, one or more output devices 54, communication interface 56, and memory 58. Server 22 may be a computing device configured to perform various tasks and interface with other devices, such as repository 24 and client computing devices (e.g., client computing device 12 of FIG. 1). Although repository 24 is shown external to server 22, server 22 may include repository 24 within a server housing in other examples. Server 22 may also include other components and modules related to the processes described herein and/or other processes. The illustrated components are shown as one example, but other examples may be consistent with various aspects described herein.

Processor 50 may include one or more general-purpose microprocessors, specially designed processors, application specific integrated circuits (ASIC), field programmable gate arrays (FPGA), a collection of discrete logic, and/or any type of processing device capable of executing the techniques described herein. In some examples, processor 50 or any other processors herein may be described as a computing device. In one example, memory 58 may be configured to store program instructions (e.g., software instructions) that are executed by processor 50 to carry out the techniques described herein. Processor 50 may also be configured to execute instructions stored by repository 24. Both memory 58 and repository 24 may be one or more storage devices. In other examples, the techniques described herein may be executed by specifically programmed circuitry of processor 50. Processor 50 may thus be configured to execute the techniques described herein. Processor 50, or any other processes herein, may include one or more processors.

Memory 58 may be configured to store information within server 22 during operation. Memory 58 may comprise a computer-readable storage medium. In some examples, memory 58 is a temporary memory, meaning that a primary purpose of memory 58 is not long-term storage. Memory 58, in some examples, may comprise as a volatile memory, meaning that memory 58 does not maintain stored contents when the computer is turned off. Examples of volatile memories include random access memories (RAM), dynamic random access memories (DRAM), static random access memories (SRAM), and other forms of volatile memories known in the art. In some examples, memory 58 is used to store program instructions for execution by processor 50. Memory 58, in one example, is used by software or applications running on server 22 (e.g., one or more of modules 60, 64, 68, and 72) to temporarily store information during program execution.

Input devices 52 may include one or more devices configured to accept user input and transform the user input into one or more electronic signals indicative of the received input. For example, input devices 52 may include one or more presence-sensitive devices (e.g., as part of a presence-sensitive screen), keypads, keyboards, pointing devices, joysticks, buttons, keys, motion detection sensors, cameras, microphones, or any other such devices. Input devices 52 may allow the user to provide input via a user interface.

Output devices 54 may include one or more devices configured to output information to a user or other device. For example, output device 54 may include a display screen for presenting visual information to a user that may or may not be a part of a presence-sensitive display. In other examples, output device 54 may include one or more different types of devices for presenting information to a user. Output devices 54 may include any number of visual (e.g., display devices, lights, etc.), audible (e.g., one or more speakers), and/or tactile feedback devices. In some examples, output devices 54 may represent both a display screen (e.g., a liquid crystal display or light emitting diode display) and a printer (e.g., a printing device or module for outputting instructions to a printing device). Processor 50 may present a user interface via one or more of input devices 52 and output devices 54, whereas a user may control the abstraction and/or coding of medical documents via the user interface. In some examples, the user interface generated and provided by server 22 may be displayed by a client computing device (e.g., client computing device 12).

Server 22 may utilize communication interface 56 to communicate with external devices via one or more networks, such as network 20 in FIG. 1, or other storage devices such as additional repositories over a network or direct connection. Communication interface 56 may be a network interface card, such as an Ethernet card, an optical transceiver, a radio frequency transceiver, or any other type of device that can send and receive information. Other examples of such communication interfaces may include Bluetooth, 3G, 4G, and WiFi radios in mobile computing devices as well as USB. In some examples, server 22 utilizes communication interface 56 to wirelessly communicate with external devices (e.g., client computing device 12) such as a mobile computing device, mobile phone, workstation, server, or other networked computing device. As described herein, communication interface 56 may be configured to receive medical documents and/or transmit abstracted and/or coded medical documents over network 20 as instructed by processor 50.

Repository 24 may include one or more memories, repositories, databases, hard disks or other permanent storage, or any other data storage devices. Repository 24 may be included in, or described as, cloud storage. In other words, information stored on repository 24 and/or instructions that embody the techniques described herein may be stored in one or more locations in the cloud (e.g., one or more repositories 24). Server 22 may access the cloud and retrieve or transmit data as requested by an authorized user, such as client computing device 12. In some examples, repository 24 may include Relational Database Management System (RDBMS) software. In one example, repository 24 may be a relational database and accessed using a Structured Query Language (SQL) interface that is well known in the art. Repository 24 may alternatively be stored on a separate networked computing device and accessed by server 22 through a network interface or system bus, as shown in the example of FIG. 2. Repository 24 may in other examples be an Object Database Management System (ODBMS), Online Analytical Processing (OLAP) database or other suitable data management system.

Repository 24 may store instructions and/or modules that may be used to perform the techniques described herein related to abstracting and/or coding medical documents. As shown in the example of FIG. 2, repository 24 includes parsing module 60, annotation module 64, abstraction module 68, and coding module 72. Processor 50 may execute each of modules 60, 64, 68, and 72 as needed to perform various tasks. Repository 24 may also include additional data such as information related to the function of each module and server 22. For example, repository 24 may include parsing information 62, dictionary 66, abstracting rules 70, coding information 74, and medical document information 76. Repository 24 may also include additional data related to the processes described herein. In other examples, memory 58 or a different storage device of server 22 may store one or more of the modules or information stored in repository 24.

Medical document information 76 may include information related to the medical documents that will be or have been analyzed by server 22. Once uploaded to server 22, server 22 may store the medical documents that will be abstracted and/or coded. In some examples, medical document information 76 may include medical documents that have already been abstracted to include semantic representations and not yet coded. Medical document information 76 may also include medical documents from one or more patients, one or more healthcare entities, or any other source. In some examples, medical documents from different patients and/or healthcare entities may be physically separated into different memories of repository 24. Processor 50 may this receive medical documents from medical document information 76 in some examples.

Once processor 50 has received a medical document to be abstracted, processor 50 may be configured to tokenize the text into one or more tokens and tag some or all of the tokens with the appropriate part of speech for the word. The tagging and tokenizing process may be performed by annotation module 64 or specific modules such as a tokenizing module (e.g., that breaks up text of the document into separate tokens) and a tagging module (e.g., that tags tokens with respective parts of speech). Processor 50 may be configured to then execute annotation module 64 to annotate one or more words of the medical document with respective concepts Annotation module 64 may retrieve each concept from electronic dictionary 66. Dictionary 66 may include one or more dictionaries, databases, or statistical annotators that each includes entries for corresponding tokens (e.g., body parts, medical devices, medical procedures, diagnoses, etc.). The dictionaries may be specific to medical concepts in a specific language (e.g., English or Spanish) and include the concepts that describe each respective token. The dictionaries may also include medical dictionaries or databases in which medical tokens are associated with respective concepts.

In addition, dictionary 66 may include any other knowledge resources that annotation module 64 may use to annotate the tokens of the medical document with respective concepts. For example, dictionary 66 may include ontological resources that conceptualize the tokens contained within medical documents. These ontological resources may define concepts related to words or phrases as needed to determine a respective medical code. Therefore, dictionary 66 may include any number of resources in which annotation module 64 can define the tokens of the medical document.

Once annotation module 64 has annotated the medical document, processor 50 may execute parsing module 60 to parse the tokens of the medical document into one or more syntactic structures. Parsing module 60 may utilize rules stored in parsing information 62 to syntactically parse the text of the medical document into the one or more syntactic structures (e.g., relationships between tokens). Parsing module 60 may analyze the parts of speech of each token (e.g., word or words) in the medical document and execute grammars based on the parts of speech to parse the text into different syntactic structures. Parsing module 60 may be configured as a rule-based parse engine where all of the rules cascade from each other. Therefore, the order of each rule may be determinative of how the text is parsed. These rules may be stored as part of parsing information 62. In one example, parsing module 60 may perform the parsing process by dividing text into sentences, the sentences into clauses, clauses into phrases (e.g. noun, verb, adverbial, and prepositional phrases), and phrases into their subparts, which may include individual words or recursively additional phrases. Such a parse may identify the actions within a document (e.g., the verbs), the arguments of those actions (e.g., the noun phrases), and the modifiers of these actions and arguments (e.g., the adverbial and prepositional phrases as well as the adjectives within noun phrases). These relationships may be generally bounded within a single clause, but may extend across multiple clauses in some examples including anaphora (e.g., determining what “it” refers to) and co-reference resolution. In this manner, parsing module 60 may be configured to break down the text into a tree structure that represents the text. These noun phrases may identify subject matter described within the medical document. Parsing module 60 may thus break down the text of the medical document into elements relatable to abstractions or concepts contained within the medical document.

Abstraction module 68 may use the parsed syntactic structures and concepts to generate semantic representations of the concepts contained within the medical document, as described herein. Processor 50 may execute abstraction module 68 to abstract, or conceptualize, the syntactic structures created from parsing module 60 with respective semantic representations based on the instructions and rules stored in abstracting rules 70. For example, abstraction module 68 may identify different semantic actions and descriptive features from related syntactic structures to generate semantic representations of the same basic concepts that may be described many different ways in the text of the document. The single semantic representation of one or more syntactic structures generated by abstraction module 68 may then include a concept that is directly relatable to a medical code. The abstraction that is the semantic representation may then be applicable to any type of medical coding system and its codeset while also reducing potential inaccuracies and difficulties in directly translating text strings of a medical document to respective medical codes. Abstraction module 68 may store the semantic representations as part of medical document information 76, such as metadata associated with the respective medical document.

Abstracting rules 70 may define how abstraction module 68 generates each semantic representation and even the form of each semantic representation. For example, abstraction module 68 may generate sematic representations in a framework that is relatable to coding module 72 as respective abstract concepts. In one example, abstracting rules 70 may define the semantic representations in the form of RDF triples. As described herein, RDF triples are a metadata model expressed in extensible markup language (XML) to describe the relationships between entities, abstract ideas, or characteristics. In an RDF triple, the subject may denote some entity, the object may denote some other entity, idea, or characteristic, and the predicate expresses the type of relationship between the subject and the object. In this manner, a format such as RDF triples may include the information needed to describe each semantic representation, but other formats may be used in other examples.

Processor 50 may also execute coding module 72 to determine a medical code, or set of codes, that corresponds to the one or more semantic representations of the medical document. Coding module 72 may operate according to the instructions stored in coding information 74. Coding information 74 may include one or more different codesets of respective medical coding systems. Each codeset may have a list or pool of possible medical codes from which coding module 72 may determine based on the semantic representations of each medical document. In addition, coding information 74 may include instructions or rules regarding which semantic representations to use during the coding process, how to select each semantic representation, when to identify that the appropriate medical code or set of codes has been selected, select default medical codes, or any other scenarios that may occur during the constraint-based coding performed by coding module 72.

As described herein, coding module 72 may be executed by processor 50 to apply different semantic representations of a medical document to a list of possible medical codes. Coding module 72 may combine semantic representations having related semantic actions into a group of semantic representations and determine one or more medical codes that match the group of semantic representations from the list of possible medical codes. In this manner, coding module 72 may constrain the possible list of medical codes with each of the semantic representations in the group of semantic representations. Although each group of semantic representations may include a plurality of semantic representations, a group may include a single semantic representation in other examples.

If coding module 72 determines multiple medical codes for a single group of semantic representations, coding module 72 may perform additional processes to select between the multiple medical codes. For example, coding information 74 may include rules that instruct coding module 72 to select the default medical code from among the multiple medical codes. Coding module 72 may perform these and any other coding processes described herein. Coding module 72 may also be configured to associate the selected medical code, or set of codes, to the medical document. For example, coding module 72 may store the medical code as metadata (or any other type of identifying information) attached to the medical document and/or as data citing the specific medical document for which the medical code applies.

After coding module 72 determines the medical code or set of codes for the medical document, processor 50 may store the medical code or set of codes in medical document information 76 to be accessed at a later time. In addition, or alternatively, processor 50 may transmit the determined medical codes for each medical document to another device, such as client computing device 12 or another server computing device via network 20 of FIG. 1. The medical code may be used by a client device or system to populate or update an EHR for the patient and/or perform billing tasks based on the treatment received by the patient from a healthcare organization.

Although server 22 is described as configured to both abstract and code a medical document, each of those processes may be performed by different computing devices in other examples. For example, server 22 may not be configured to select the medical code for the medical document and/or repository may not include coding module 72 and coding information 74. Instead, server 22 may be configured to abstract medical documents with semantic representations and transmit the abstraction to another device, such as another server computing device, that is configured to perform the coding of the medical documents based on the respective semantic representations. In this manner, different devices or systems may be configured to handle the tasks of abstraction and coding of the medical documents.

As described herein, the abstractions of medical documents may be applicable to many or all of the different medical coding systems. Since the text has been abstracted from the actual words used by a healthcare professional, the abstractions from the medical document may be coded by different codesets and result in consistent coding that is minimally affected by language nuances within the text. Example medical coding systems may include the International Classification of Diseases (ICD) codes (versions 9 and 10), Current Procedural Technology (CPT) codes, Healthcare Common Procedural Coding System codes (HCPCS), and Physician Quality Reporting System (PQRS) codes. Each of the medical coding systems may include a codeset from which each medical code is obtained. In some examples, processor 50 may select the appropriate codeset from coding information 74 when multiple codesets are available.

FIG. 3 is a block diagram illustrating a stand-alone computing device 100 configured to abstract and/or code medical documents. Computing device 100 may be substantially similar to server 22 and repository 24 of FIG. 2. However, computing device 100 may be a stand-alone computing device configured to perform the abstraction and coding of medical documents. Computing device 100 may be configured as a workstation, desktop computing device, notebook computer, tablet computer, mobile computing device, or any other suitable computing device or collection of computing devices.

As shown in FIG. 3, computing device 100 may include processor 110, one or more input devices 114, one or more output devices 116, communication interface 112, and one or more storage devices 120, similar to the components of server computing device 22 of FIG. 2. Computing device 100 may also include communication channels 118 (e.g., a system bus) that allows data flow between two or more components of computing device 100, such as between processor 110 and storage devices 120. Computing device 100 also includes one or more storage devices 120, such as a memory, that stores information such as instructions for performing the processes described herein and data such as medical documents and data attached to medical documents such as tags, tokens, annotations, parses, abstractions, and medical codes.

Storage devices 120 may include data for one or more modules and information related to the abstraction and coding of medical documents described herein. For example, storage devices 120 may include parsing module 124, annotation module 128, abstraction module 132, and coding module 136, similar to the modules described with respect to repository 24 of FIG. 2. Storage devices 120 may also include information such as parsing information 126, dictionary 130, abstracting rules 134, coding information 138, and medical document information 140, similar to the information described as stored in repository 34.

The information and modules of storage devices 120 of computing device 100 may be specific to a healthcare entity that employs computing device 100 to abstract and code medical documents generated by healthcare professionals associated with the healthcare entity. For example, coding information 138 may contain a specific codeset that is used by the healthcare entity. In any case, computing device 100 may be configured to perform any of the processes and tasks described herein and with respect to server 22 and repository 24. Storage devices 120 may also include user interface module 122, which may provide a user interface for a user via input devices 114 and output devices 116.

In some examples, input devices 114 may include one or more scanners or other devices configured to convert paper medical documents into electronic medical documents that can be analyzed by computing device 100. In other examples, communication interface 112 may receive electronic medical documents from a repository or individual clinician device on which the medical documents are initially generated. Communication interface 112 may thus send and receive information via a private or public network.

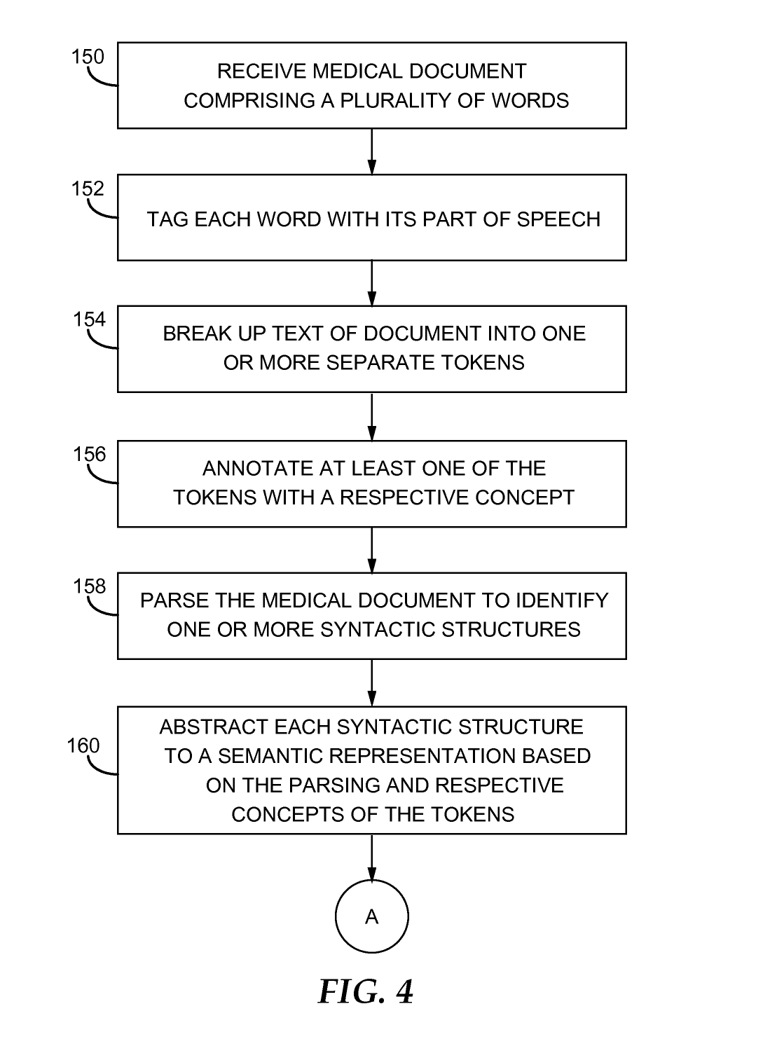

FIG. 4 is a flow diagram illustrating an example technique for abstracting one or more syntactic structures of a medical document. FIG. 4 will be described from the perspective of sever 22 and repository 24 of FIGS. 1 and 2, although computing device 100 of FIG. 3, any other computing devices or systems, or any combination thereof, may be used in other examples. As shown in FIG. 4, processor 50 may initially receive a medical document (e.g., an electronic document) that includes a plurality of words (150). Processor 50 may receive the medical document from a client computing device 12, medical document information 76, or any other location. The medical document may already be regioned, or segmented into different sections that each identifies different aspects of the medical document (e.g., diagnosis, procedure, procedure outcome, etc.). Although a single medical document is described, processor 50 may receive multiple medical documents and perform similar processes on each of the medical documents. In other examples, processor 50 may actively obtain medical documents available for abstraction and coding. For example, processor 50 may communicate with one or more client computing devices (e.g., client computing device 12) or repositories at scheduled or periodic times to collect available medical documents.

Responsive to receiving the medical document, processor 50 may tag each word in the text of the medical document with its respective part of speech (e.g., verbs, nouns, pronouns, adverbs, etc.) (152). Processor 50 may then break up the text of the medical document into one or more separate tokens (154). Each token may include one word or a plurality of words. This process of breaking up the text into different tokens may be referred to as “tokenizing” the text. In other examples, the medical document may be tokenized prior to being received by processor 50. Although the tagging of each word with parts of speech is described as occurring before the tokenization process, processor 50 identification of parts of speech for words or tokens in the text may occur at any point prior to the parsing step of block 158. For example, processor 50 may first tokenize the document into separate tokens and then tag each token with its respective part of speech.

After the text has been tokenized, processor 50 annotates (e.g., with annotation module 64) at least one of the tokens in the medical document with a respective concept (156). In some examples, a token may be annotated with one or more respective concepts. The one or more respective concepts may conceptualize the token and thus remove variations in language from later processes in the abstraction and coding processes. Processor 50 may annotate one or more tokens with concepts stored in one or more dictionaries or other concept repositories. Alternatively, processor 50 may statistically identify the concepts of respective tokens. Responsive to annotating the one or more tokens of the medical document, processor 50 parses (e.g., with parsing module 66) the medical document to identify at least some of the one or more syntactic structures within the document (158). Each of the syntactic structures may include one token or a plurality of tokens, such as semantic actions and descriptive features (e.g., nouns, adjectives, adverbs, etc.) to describe relationships between tokens. Each syntactic structure may group certain parts of speech or related parts of speech that modify other tokens. This type of parsing may then narrowly describe the concepts of the medical document without redundant or unnecessary words or tokens contained within the text. In some examples, the parsing process breaks down various sentences, clauses, verbs, nouns, etc. using syntax to create a tree structure of different syntactic structures.

Responsive to parsing the medical document, processor 50 may abstract (e.g., with abstraction module 68) each of the syntactic structures to a semantic representation based on the parsing and respective concepts (160). In this manner, processor 50 may generate one or more semantic representations for the medical document. These semantic representations may conceptualize the text of the medical document that can then be related to respective medical codes from any type of medical coding system. The abstractions provided by the semantic representations may then allow the coding process to relate to the concepts described by the text in the medical document instead of the text itself. By applying the abstract concepts to possible medical codes, the coding process may not be hindered by text string searches that may cause inaccurate or incomplete coding.

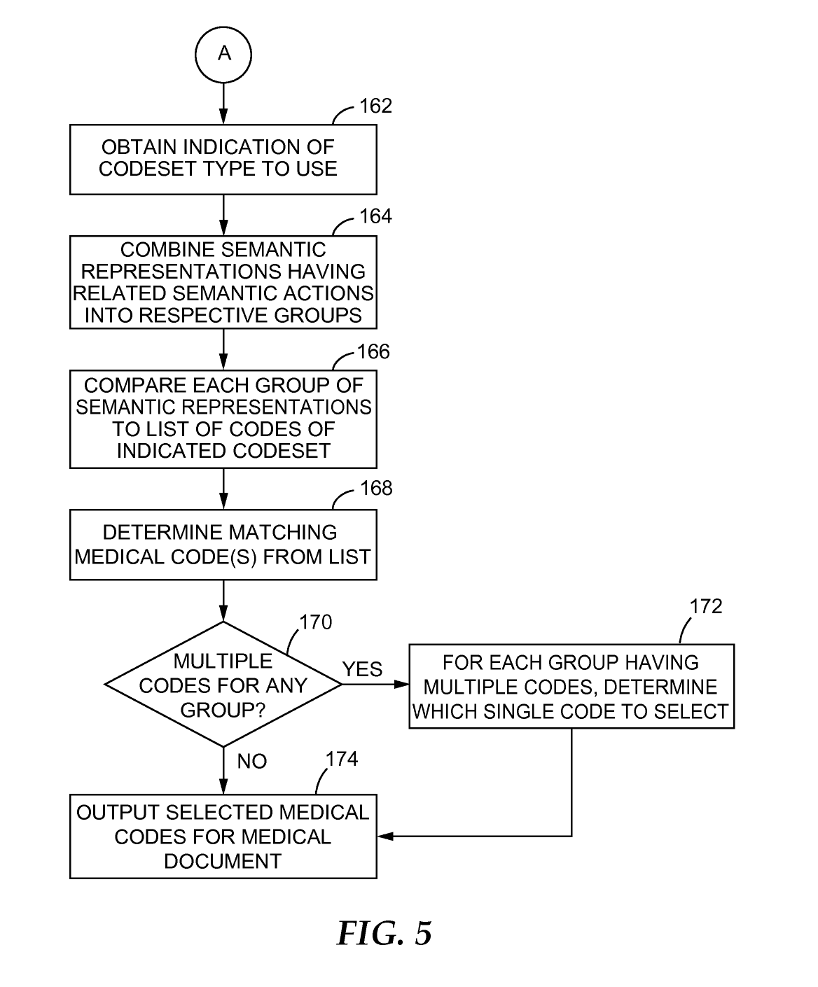

After processor 50 completes the abstraction process of block 160, processor 50 may store the semantic representations in metadata attached to the medical document, for example. The abstracted medical document may be stored in repository 24, for example, until the document is ready to be coded or transmitted back to the client in other examples. Processor 50 may move to block A continued in FIG. 5 to perform an example coding process described herein.

FIG. 5 is a flow diagram illustrating an example technique for coding a medical document using semantic representations associated with the medical document. FIG. 5 will be described from the perspective of sever 22 and repository 24 of FIGS. 1 and 2, although computing device 100 of FIG. 3, any other computing devices or systems, or any combination thereof, may be used in other examples. Although FIG. 5 may be a continuation of the process described in FIG. 4, FIG. 5 may refer to an independent process in other examples.

As shown in FIG. 5, processor 50 may code the medical document that was abstracted in FIG. 4, from block A. Processor 50 may obtain an indication of which codeset type to use when coding the medical document (162). For example, a request received from client computing device 12 may include an indication of which codeset should be applied. Alternatively, medical document information 76 may include an indication of which codeset to use. Processor 50 may need to identify the codeset to use in order to determine to which list of codes the semantic representations of the abstracted medical document should be applied.

Processor 50 may then (e.g., via coding module 72), combine semantic representations having related semantic actions into respective groups of semantic representations (164). Each of the semantic representations of the medical document may include a semantic action that indicates something about the subject of the semantic representation or what occurred in the semantic representation. Each semantic action may be referred to as a predicate, which may be derived from a noun, verb, or other token. In a medical document, there may be multiple different semantic representations with related semantic actions. This may occur when the medical professional describes the procedures or conditions of the patient. In some examples, the related semantic actions may be the same semantic actions or semantic actions otherwise related to similar concept. The different semantic representations within a single group may then more clearly identify a procedure, process, diagnosis, or any other medical item associated with the patient than a single semantic representation can describe. Therefore, each of the semantic representations within the group is a constraint on possible medical codes applicable to the medical document. However, in some examples, a group of semantic representations may only include one semantic representation. The single semantic representation may be sufficient to determine a single matching medical code in some examples.

Processor 50 then compares each group of semantic representations to the list of codes of the indicated codeset (166) and determines, or selects, one or more respective matching medical codes from the list of possible codes (168). If processor 50 only selects one matching code from the list of possible codes for each group of semantic representations (“NO” branch of block 170), processor 50 may output the selected one or more medical codes for the medical document (174). Outputting the medical code may include adding the medical code as metadata to the medical document and/or transmitting the medical code to another device such as client computing device 12. If processor 50 determines that there are more than one medical codes selected as matching any group of semantic representations (“YES” branch of block 170), processor 50 may determine which single code to select for each group having multiple matching medical codes (172). In some examples, processor 50 may select, from the multiple matching medical codes, a default code for the group of semantic representations. The default code may be stored as a part of one or more rules (e.g., rule-based constraints) identifying default codes or default selections to distinguish between multiple codes. The rules defining default codes may be generated based on feedback from medical coding experts, medical professionals, or any other experience-based knowledge base. For example, the multiple matching medical codes may refer to different details about a particular medical procedure, one code related to a common procedural detail and the other codes related to rarely used procedural details. In other examples, the process of selecting from multiple medical codes may include processor 50 statistically determining which of the multiple codes are most likely to be applicable to the semantic representations of the group. In some examples, processor 50 may predict the medical code based on the remaining medical codes and/or the medical codes that have been excluded from consideration prior to reaching block 172. Processor 50 may, for example, exclude remaining medical codes that are not related to the other codes already determined in block 168 or exclude remaining medical codes similar to previously excluded codes.

In another example of further reducing the number of possible medical codes in block 172, processor 50 may apply additional rule-based constraints on the remaining possible medical codes. Processor 50 may apply these rule-based constraints in reverse, such as by applying medical codes as constraints to the medical document to determine if any of the medical codes match the rest of the document. Processor 50 may identify syntactic structures of the medical document related to the remaining medical codes and generate semantic representations of the medical codes and compare them to the semantic representations of the medical document and determine if there are any matches. In one example, processor 50 may run a query of the medical code semantic representations transformed into SPARQL (SPARQL Protocol and RDF Query Language) which is applied against the RDF triples (i.e., the semantic representations) of the medical document. If processor 50 determines a match, processor 50 may select the corresponding medical code to define the medical document.

If processor 50 determines that multiple medical codes still remain for a group of semantic representations, processor 50 may not output any medical code in some examples. In other words, the inability to select a single medical code for the group of semantic representations may indicate that the text of the medical document provides insufficient information to correctly code the medical document. Therefore, processor 50 may withhold all of the multiple medical codes for a group of semantic representations from being output for the medical document.

As described herein, a medical document may include one or more different regions, sections, pages, or portions related to the condition and/or treatment of a medical patient. Therefore, description of a medical document may refer to the entire physical document, a portion of the medical document, or any portion of an electronic medical document or medical record. Although medical documents may typically be segmented into “pages” that may or may not be limited to a specific type of medical information, the abstraction and coding techniques described herein are not limited to abstraction and coding of segmented pages or documents. Instead, different regions of a medical document may be separately abstracted and/or coded, regardless of how the information of the medical document is visually segmented or represented.

The techniques of this disclosure may be implemented in a wide variety of computer devices, such as one or more servers, laptop computers, desktop computers, notebook computers, tablet computers, hand-held computers, smart phones, or any combination thereof. Any components, modules or units have been described to emphasize functional aspects and do not necessarily require realization by one or more different hardware units.

The disclosure contemplates computer-readable storage media comprising instructions to cause a processor to perform any of the functions and techniques described herein. The computer-readable storage media may take the example form of any volatile, non-volatile, magnetic, optical, or electrical media, such as a RAM, ROM, NVRAM, EEPROM, or flash memory that is tangible. The computer-readable storage media may be referred to as non-transitory. A server, client computing device, or any other computing device may also contain a more portable removable memory type to enable easy data transfer or offline data analysis.

The techniques described in this disclosure, including those attributed to server 22, repository 24, and/or computing device 100, and various constituent components, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, remote servers, remote client devices, or other devices. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. For example, any of the techniques or processes described herein may be performed within one device or at least partially distributed amongst two or more devices, such as between server 22 and/or client computing device 12. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Example computer-readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or any other computer readable storage devices or tangible computer readable media. The computer-readable storage medium may also be referred to as storage devices.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described herein. Any combination of the described operations or functions is contemplated. These and other examples are within the scope of the following claims.

What is claimed is:

1. A computer-implemented method for coding medical documentation, the method comprising:
receiving, by a computing device, a medical document comprising a plurality of tokens;
annotating, by the computing device, at least one of the plurality of tokens with one or more concepts;
parsing, by the computing device, the plurality of tokens of the medical document to identify one or more syntactic structures;
abstracting, by the computing device, each of the one or more syntactic structures to a semantic representation based on the parsing and the respective concepts;
determining, by the computing device and based on the semantic representation of at least one of the respective one or more syntactic structures, one or more medical codes representative of information contained in the medical document; and
outputting, by the computing device, the medical code for the medical document.

2. The method of claim 1, wherein:
annotating the at least one of the plurality of tokens with the concept comprises annotating multiple of the plurality of tokens with respective concepts;
abstracting each of the one or more syntactic structures to the semantic representation comprises abstracting each of a plurality of syntactic structures to a respective semantic representation based on the parsing and the respective concepts; and
determining the one or more medical codes representative of information contained in the medical document comprises:
combining semantic representations having related semantic actions into a group of semantic representations; and
determining, for the group of semantic representations, a single one of the one or more medical codes.

3. The method of claim 2, wherein the group of semantic representations is a first group, the related semantic actions are first related semantic actions, and the single one of the one or more medical codes is a first medical code, and wherein determining the one or more medical codes further comprises:
for each set of related semantic actions, combining semantic representations having the respective set of related semantic actions into respective groups of semantic representations; and
determining, for each of the respective groups of semantic representations, a respective medical code of the one or more medical codes.

4. The method of claim 2, wherein each semantic representation comprises a common semantic action and one or more respective descriptive features, and wherein combining semantic relationships comprises:
combining, into the group of semantic representations, semantic representations having the common semantic action and related descriptive features.

5. The method of claim 2, wherein determining the single one of the one or more medical codes comprises:
comparing the group of semantic representations to a list of possible medical codes; and
selecting, based on the comparison, the single one medical code matching the group of semantic representations.

6. The method of claim 1, wherein:
annotating the at least one of the plurality of tokens with the concept comprises annotating multiple of the plurality of tokens with respective concepts;
abstracting each of the one or more syntactic structures to the semantic representation comprises abstracting each of a plurality of syntactic structures to a respective semantic representation based on the parsing and the respective concepts; and
determining the one or more medical codes representative of information contained in the medical document comprises:
combining semantic representations having related semantic actions into a group of semantic representations;
determining, for the group of semantic representations, multiple possible medical codes; and
selecting, for the group of semantic representations, a default medical code from the multiple possible medical codes as one of the one or more medical codes.

7. The method of claim 1, further comprising:
receiving the medical document comprising a plurality of words;
tagging at least some of the plurality of words with a respective part of speech; and
tokenizing text of the medical document into the plurality of tokens, and wherein parsing the medical document comprises parsing, based on respective parts of speech identified during the tagging, the medical document to identify the one or more syntactic structure.

8. The method of claim 1, wherein annotating the at least one of the plurality of tokens comprises:
matching each of the at least one of the plurality of tokens to a respective entry of one or more electronic dictionaries, each entry comprising a respective concept related to a respective token; and
applying, for each of the at least one of the plurality of tokens, the respective concept to the respective token.

9. The method of claim 1, wherein each of the one or more tokens comprise one of a word or a phrase comprising two or more words.

10. A computerized system for coding medical documentation, the system comprising:
one or more computing devices configured to:
receive a medical document comprising a plurality of tokens;
annotate at least one of the plurality of tokens with one or more concepts;
parse the plurality of tokens of the medical document to identify one or more syntactic structures;
abstract each of the one or more syntactic structures to a semantic representation based on the parsing and the respective concepts;
determine, based on the semantic representation of at least one of the respective one or more syntactic structures, one or more medical codes representative of information contained in the medical document; and
output the medical code for the medical document.

11. The system of claim 10, wherein the one or more computing devices are configured to:
annotate multiple of the plurality of tokens with respective concepts;
abstract each of a plurality of syntactic structures to a respective semantic representation based on the parsing and the respective concepts; and
determine the one or more medical codes representative of information contained in the medical document by:
combining semantic representations having related semantic actions into a group of semantic representations; and
determining, for the group of semantic representations, a single one of the one or more medical codes.

12. The system of claim 11, wherein the group of semantic representations is a first group, the related semantic actions are first related semantic actions, and the single one of the one or more medical codes is a first medical code, and wherein the one or more computing devices are configured to determine the one or more medical codes by:
for each set of related semantic actions, combining semantic representations having the respective set of related semantic actions into respective groups of semantic representations; and
determining, for each of the respective groups of semantic representations, a respective medical code of the one or more medical codes.

13. The system of claim 11, wherein each semantic representation comprises a common semantic action and one or more respective descriptive features, and wherein the one or more computing devices are configured to combine semantic relationships by:
combining, into the group of semantic representations, semantic representations having the common semantic action and related descriptive features.

14. The system of claim 11, wherein the one or more computing devices are configured to determine the single one of the one or more medical codes by:
comparing the group of semantic representations to a list of possible medical codes; and
selecting, based on the comparison, the single one medical code matching the group of semantic representations.

15. The system of claim 10, wherein the one or more computing devices are configured to:
annotate multiple of the plurality of tokens with respective concepts;
abstract each of a plurality of syntactic structures to a respective semantic representation based on the parsing and the respective concepts; and
determine the one or more medical codes representative of information contained in the medical document by:
combining semantic representations having related semantic actions into a group of semantic representations;
determining, for the group of semantic representations, multiple possible medical codes; and
selecting, for the group of semantic representations, a default medical code from the multiple possible medical codes as one of the one or more medical codes.

16. The system of claim 10, wherein the one or more computing devices are configured to:
receive the medical document comprising a plurality of words;
tag at least some of the plurality of words with a respective part of speech;
tokenize text of the medical document into the plurality of tokens; and
parse the medical document by parsing, based on respective parts of speech identified during the tagging, the medical document to identify the one or more syntactic structure.

17. The system of claim 10, wherein the one or more processors are configured to annotate the at least one of the plurality of tokens by:
matching each of the at least one of the plurality of tokens to a respective entry of one or more electronic dictionaries, each entry comprising a respective concept related to a respective token; and
applying, for each of the at least one of the plurality of tokens, the respective concept to the respective token.

18. The system of claim 10, wherein each of the one or more tokens comprise one of a word or a phrase comprising two or more words.

19. A computer-readable storage medium comprising instructions that, when executed, cause one or more processors to:
receive a medical document comprising a plurality of tokens;
annotate at least one of the plurality of tokens with one or more concepts;
parse the plurality of tokens of the medical document to identify one or more syntactic structures;
abstract each of the one or more syntactic structures to a semantic representation based on the parsing and the respective concepts;
determine, based on the semantic representation of at least one of the respective one or more syntactic structures, one or more medical codes representative of information contained in the medical document; and
output the medical code for the medical document.

20. The computer-readable storage medium of claim 19, wherein:
the instructions that cause the one or more processors to annotate the at least one of the plurality of tokens with the concept comprise instructions that cause the one or more processors to annotate multiple of the plurality of tokens with respective concepts;
the instructions that cause the one or more processors to abstract each of the one or more syntactic structures to the semantic representation comprise instructions that cause the one or more processors to abstract each of a plurality of syntactic structures to a respective semantic representation based on the parsing and the respective concepts; and
the instructions that cause the one or more processors to determine the one or more medical codes representative of information contained in the medical document comprise instructions that cause the one or more processors to:
combine semantic representations having related semantic actions into a group of semantic representations; and
determine, for the group of semantic representations, a single one of the one or more medical codes.
